(19) United States
(12) Patent Application Publication
(10) Pub. No.: US 2006/0260718 A1
(43) Pub. Date: Nov. 23, 2006

(54) MATERIAL, LOG AND LUMBER IDENTIFICATION THROUGH VIDEO RECOGNITION

(75) Inventors: Stanford Neglay, Albany, OR (US); Donald Neglay, Albany, OR (US); Michael Warren, Albany, OR (US); Jeffery Warren, Albany, OR (US)

Correspondence Address: PATENTTM.US, P. O. BOX 82788, PORTLAND, OR, 97282-0788, US

(73) Assignee: MAXI MILL, INC., Albany, OR (US)

(21) Appl. No.: 11/419,956

(22) Filed: May 23, 2006

Related U.S. Application Data
(60) Provisional application No. 60/683,895, filed on May 23, 2005.

(51) Int. Cl. B27B 1/00; B23Q 16/00; B23Q 15/00

(52) U.S. Cl. 144/356

(57) ABSTRACT

Systems and methods provide for identifying, tracking, and coordinating the processing of natural materials in a process. The unit material is scanned to determine natural physical characteristics. At least portions of these scanned characteristics are quantified and classified, then recorded as the unique identifier for the unit. The material may then be stored, shipped, or transferred to a further process, where the material is once again scanned for natural characteristics, compared to a library of previously recorded units and their characteristics, then processed, inventoried, tracked, or invoiced based on previous data associated with this specific unit, thereby eliminating the need for bar coding or other physical marking methods.

### BACKGROUND OF THE INVENTION

This invention relates to methods and apparatus for identifying and tracking units of raw materials based on unique natural characteristics.

As the complexity of raw material processing increases, and with the advancements in internal and external scanning methods, it becomes impractical, or expensive, to perform an exhaustive analysis of a piece at the point of processing. It is often far better to examine the unit earlier, where there is more time and space. To be useful, this information must be stored, and later correlate back to the specific unit. Currently, this requires a bar code, or other marking system, that places a physical mark, or tag, on the piece. This mark, or tag, may be difficult and expensive to apply, cosmetically undesirable, lost, become unreadable, interfere with the processing, or contaminate the by products and waste material.

In the example of processing of logs, the mass of information being evaluated in creating the most valuable solution for sawing the log can require more time than is practically acceptable in a production oriented setting. As a result the individual log/lumber may be pre-scanned or pre-evaluated with a system that is not in the critical time path. By scanning and evaluating the lumber or log prior to the processing procedure the predetermined solution can be ready for immediate implementation during the processing procedure. In order to accomplish this, the predetermined solution must be somehow linked to the corresponding log/lumber that was pre-evaluated.

The linking of a log/lumber with the appropriate predetermined solution has been accomplished in the past by means of queuing (e.g. once scanned, the logs are placed in order and supplied to be sawn in the known order, so the sawing solution is employed based on the position in line that the current log had) or by attaching an identification “tag” to the log/lumber. Since identification “tags” must be easily attached, be inexpensive, and be quickly read with great accuracy, bar coding has been the only practical method of identification.

### SUMMARY OF THE INVENTION

In accordance with the invention, by measuring, classifying, and assigning the unit an identifier based on its naturally occurring physical anomalies, nature's bar code if you will, the piece may be later identified without the tribulations of a separate physical identifier.

Accordingly, it is an object of the present invention to provide an improved system for identifying and tracking units of raw materials based on natural characteristics of the material.

It is a further object of the present invention to provide an improved system to process logs and lumber.

It is yet another object of the present invention to provide an improved system and method for processing materials.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is an end view of a grain pattern of a log indicating factors that can be considered to identify a log;

FIG. 2 is a flow chart of the steps of scanning a log;

FIG. 3 is a flow chart of the steps of later recognizing a previously scanned log;

FIG. 4 is a block diagram of an input processing side of a system according to the invention; and

FIG. 5 is a block diagram of a further processing side of a system according to the invention.

### DETAILED DESCRIPTION

The system according to a preferred embodiment of the present invention comprises methods and apparatus to examine a log or other materials and use the material's naturally occurring features to uniquely identify the material for later recognition in another part of a process.

In a particular embodiment, end grain patterns of logs or lumber are used for identification.

A unit of raw, or in process, material is scanned using conventional electronic methods to identify unique, naturally occurring characteristics. These characteristics are classified and recorded, then become the unique identifiers or “finger print” for the material. Further conventional scanning and computation may occur to determine other aspect such as: size, weight, color, content, defects, shape, and the optimum method of processing. At some subsequent stage, the material is re-scanned to recognize the naturally occurring characteristics as before. This later scan is compared to the library of previously recorded “finger prints” to match the unit to previous stored data.

The result is that material can be scanned, and data stored, at an early stage where it is easier and more cost effective. The data is stored with the assigned “natural finger print” much like a conventional bar code but without the need to ever physically mark or tag the unit. The material may then be scanned later for its “natural finger print” and matched to the detailed information from earlier, more exhaustive scanning and computation.

A unit of raw, or in process, material may comprise biological materials such as whole tree stems, wood logs, wood pieces, other biological materials such as fruits or vegetables, or animals, or units of materials such as granite blocks, rocks, stones, and such.

The scanning may be accomplished using conventional methods to identify unique, naturally occurring characteristics. These methods may comprise examining on one, or more, surfaces or internally using conventional methods such as visual imaging, Infrared, Ultraviolet, X Ray, Ultrasonic, spectral, or other systems that may derive geometric, physical, chemical, or other unique external, or internal, characteristics.

The characteristics may comprise natural or created defects such as knots, grain, splits, colors, shape, density, wane, dimensions, and defects of wood units, fissures, aggregate content, color, internal structure, geometric shape, and defects of mineral units, color, weight, content, shape, internal characteristics of animals or parts of animals such as poultry, swine, cattle, and such, or fruits and vegetables to be processed, tracked, sorted, and so on.

These characteristics are classified, classification being based on a combination of characteristics such as color, contrast, density, composition, size, and shape, and their relative locations or patterns, and recorded through conventional electronic means such as a computer or control system, and then become the unique identifier or “finger print” for the material. Further conventional scanning and computation may occur to acquire other characteristics such as overall size and shape, or internal features to be used to determine the optimum utilization (other aspects may include weight, color, content, defects, shape, as well as the optimum method of processing. The material may then be sorted and routed or stored without the need to further mark the material. At some subsequent stage, the material is rescanned to recognize the naturally occurring characteristics as before and this is compared to the library of previously recorded “finger prints” to match the unit to previous computational data. The previous data is matched to the “finger print” to control further routing, or processing. For example, tree stems may be cut to length and sorted based on a decision made some time ago. Logs may be rotated, positioned, and sawn without rescanning. Wood pieces can be edged, trimmed, or sorted without requiring that they remain in strict sequence.

The butt ends of trees length stems, or pre cut logs, can be scanned in the woods, either by a person or harvester machine mounted system and stored with the tract information, truck and driver, size and weight, scale, grade, etc. When the stem arrives at the mill site, the butt ends are scanned and correlated back to the previous information. When the stem or log enters the mill for processing, the butt end is scanned again for inventory control and further information, such as the bucking cut pattern, may be added to the previous information. When the stem is cut into logs, the end of each log is scanned and each log gets an identifier. The log may also be scanned for optimized cutting patterns, grade, or desired orientation. Once the log reaches the carriage, or other primary breakdown machine, the end is scanned again the previous solution data is retrieved. The log may then be tracked, oriented, loaded, and processed based on some previous scanning and computation perhaps from the bucking scanning and optimization system. This log grade and yield can then be tracked back to the very stem and land tract to confirm timber cruising expectations.

The ends of the logs may be scanned to identify desired routes or sorted far down stream from the initial scanning system without the need to track each log.

The ends of the logs may be scanned to identify them after they have been placed in bulk storage or accumulated on transfers without the fear of getting out of sequence.

Stems may be scanned lineally far up stream for identification and optimization, accumulated on decks. Then, as the system approaches the cut up saw system, the butt end is rescanned and the solution it retrieved for processing. This eliminates the need to scan directly in front of the sawing system, or to keep strict separations of the stems after scanning to prevent getting stems out of sequence.

Ends of cants (two of four sided logs) can be scanned to recognize the grain and defect patterns, and correlated back to a previous optimized solution from the log processing machine, or even earlier at the log cut up system.

Ends of lumber are scanned for their “finger print” and matched up to previously determined edger, trimmer, or sort solutions.

A unique benefit of this system is that a company may invest in a single geometric or internal defect scanning system machine, with localized scanning and optimization and create a complete solution for the material. This more complex scanning and computational system can then process the data off line, maximizing the available processing time to achieve the absolute optimum solution. The system is insensitive to the orientation, and because the “finger print” is not dependent on any one given characteristic, it is able to ignore minor changes such as color fading.

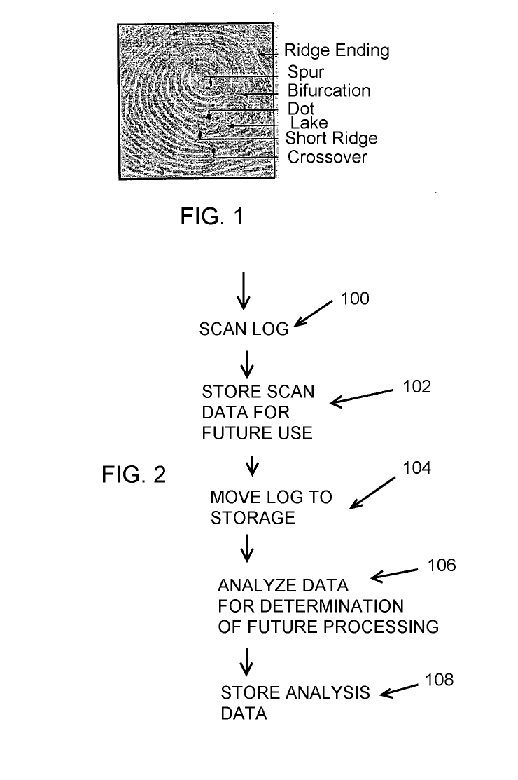

FIG. 1 illustrates an example end of a log, for example, where ridge ending, spurs, bifurcation, dots, lakes, short ridges and crossovers may be employed as identifying factors.

FIG. 2 is a flow chart of steps in scanning a log, for example, wherein in step 100, the log is scanned, and the data thereby generated is stored for future use (step 102). The scanned log may then be conveyed to storage, for example, to await further processing (step 104). Next, an optional step 106, which may be employed in a particular embodiment, analyzes some or all of the data for determination of future processing of the log. This may comprise determination of optimal sawing configuration for maximum yield, whether in terms of maximum usable lumber or maximum profit, for example. The analysis step can be accomplished at any time after the log has been scanned, and may involve as noted herein, substantial computational analysis to determine optimal use or further processing of the log. The analysis data may then be suitably stored for retrieval later in connection with later processing of this log (step 108).

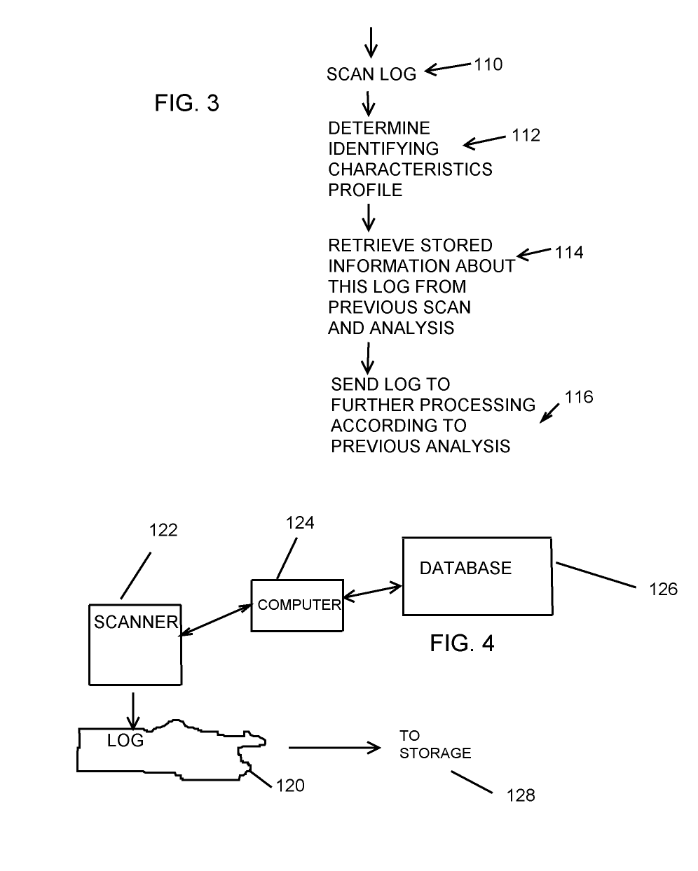

FIG. 3 is a flow chart of steps when retrieving a log, wherein in step 110, the retrieved log is scanned for identifying characteristics, and the identifying characteristics are determined (step 112). The stored information about this particular log is then retrieved, since the log has been identified (step 114) and the log is then appropriately sent to further processing in accordance with interpretation of the analysis (step 116).

FIG. 4 is a block diagram of an input side of the system, wherein the incoming material, such as log 120 is passed through scanning position, wherein scanner 122 will scan the log under control of computer 124, whereupon the log data is stored in a database 126 for future reference. The log is then suitably sent to storage 128, to be held until some future time when the log is picked up for further processing.

Some of the scan data, for example, in the case of a log, the end grain pattern information portion of the scan, is employed to develop and identification key for the log which is then employed to link this log with its scan data in the future. The scan data in the database can include further information beyond the end grain patter, for example, and overall configuration scan to represent the shape of the log, or, other scanner information. The scan data may be provided to other computational equipment which can perform analysis of the scan data for future reference, such as optimal cutting information, defect detection, etc. This data can then be used in future processing of this log.

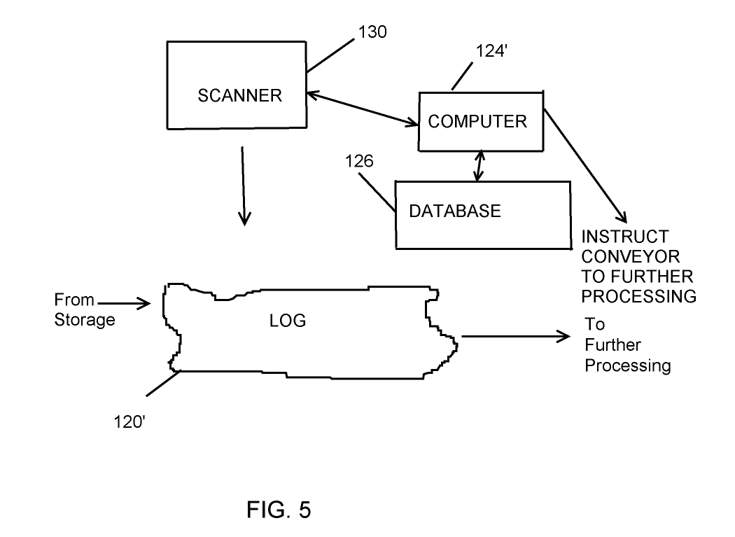

Referring to FIG. 5, a block diagram of a later processing phase when the log is retrieved from storage, the log 120′ is conveyed from storage and again scanned by scanner 130 (typically at a different scanning location, although the same scanner as before can be employed if the system is so implemented) wherein scanner 130 suitably will be looking to scan only the identification portions of the log (e.g., the end grain patterns). Computer 124′ receives the scanner data, and, uses the scanned data to determine the identification of the log so as to retrieve the log's data from database 126. This data will typically include information that computer 124′ uses to determine what further processing is to be made upon this particular log, and the computer will direct the conveying system to transfer to log to the appropriate further processing station or system. Further processing could include specific sawing operations (where the sawing instructions could be transmitted to the sawing system), defect removal station (wherein a portion of the log is removed or processed to eliminate defects), or other suitable processing.

Some applications of the system are:

Pre scanning for positioning a log on a sawmill primary breakdown system such as Double Length Infeed or a carriage, etc.

Lineal planer graders to keep boards in sequence.

Tracking boards for return to a sawmill resaw.

Fingerprint, face, palm print, etc. recognition technology may suitably be employed to analyze and match the material items.

The preferred embodiment is to employ the system and methods in log and lumber production. Since each log/lumber has a unique combination of growth rings and/or face grain, and these natural characteristics of wood are as unique as a human fingerprint. Accordingly a high resolution vision system and a high speed computer can identify each log or piece of lumber without the necessity of attaching a “tag” or keeping the log/lumber in queue.

Thus, in accordance with the invention, each log may be scanned and the appropriate solution for sawing stored together with identification data based on the vision system recognizing the “fingerprint” of the log, whether it be on the overall shape characteristics or the growth ring and/or face grain of the individual log.

Then, later, as a log arrives to a sawing station, another vision scan is made and the scan information is employed to recognize that log to enable retrieval of the sawing solution information particular to that individual log.

This system removes the need for queuing the logs or processing them or storing them in any particular order or location, and removes need for the attachment of labels or other physical id tags to the log.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A system for processing materials, comprising:
a scanning system for scanning a material to record characteristics of the material and generating and storing an identification profile of the material.

2. The system according to claim 1, wherein said material comprises logs.

3. The system according to claim 1, wherein said material comprises wood pieces.

4. The system according to claim 1, wherein said material comprises fruits.

5. The system according to claim 1, wherein said material comprises vegetables.

6. The system according to claim 1, wherein said material comprises animals.

7. The system according to claim 1, wherein said material comprises material selected from the group consisting of granite blocks, rocks and stones.

8. A system for processing material, comprising:
a scanner at an input side for retrieving physical characteristics of the material at an input phase;
a computing system for determining an identification key for the material based on at least a portion of the scanned physical characteristics;
storage database for storing the retrieved physical characteristics and identification key;
a scanner at a retrieval side for re-scanning the material to re-acquire at least a scan of identification characteristics portions for the material at the retrieval side;
a computing system for determine an identification key for the re-acquired scan and for retrieving data from the storage database based thereon, and, for directing the material to appropriate further processing based on the retrieved data.

9. The system according to claim 8, further comprising a computing system for processing the physical characteristics data stored in said storage database to determine appropriate further processing of said material and storing said further processing data in said database.

10. The system according to claim 8, wherein said material comprises logs.

11. The system according to claim 8, wherein said material comprises wood pieces.

12. The system according to claim 8, wherein said material comprises fruits.

13. The system according to claim 8, wherein said material comprises vegetables.

14. The system according to claim 8, wherein said material comprises animals.

15. The system according to claim 8, wherein said material comprises material selected from the group consisting of granite blocks, rocks and stones.

16. A method of handling material for processing comprising the steps of:
scanning the material at an input side to determine physical characteristics thereof and storing said determined physical characteristics as scan data;
employing at least portion of said scan data to develop an identification for said material;
storing said material for further processing at a future time;
performing further processing on the scan data to determine desired further processing for the material and storing results thereof;
retrieving the material from storage;
scanning the material at a retrieval stage to obtain identification data for the material;
retrieving the stored further processing results related to the material scanned at the retrieval stage; and
directing further processing based thereon.

17. The method according to claim 16, wherein said material comprises logs, lumber or wood pieces.

18. The method according to claim 16, wherein said material comprises fruits.

19. The method according to claim 16, wherein said material comprises vegetables, fruit or animals.

20. The method according to claim 16, wherein said material comprises material selected from the group consisting of granite blocks, rocks and stones.
